(19) United States
(12) Patent Application Publication
(10) Pub. No.: US 2023/0325847 A1
(43) Pub. Date: Oct. 12, 2023

(54) AUTOMATED DOCUMENT AUDITING METHOD AND SYSTEM

(71) Applicant: SoftWorks Al, LLC, Forest Hills, NY (US)

(72) Inventors: Ari Gross, West Hempstead, NY (US); Aaron Goldblatt, Flushing, NY (US)

(21) Appl. No.: 18/133,424

(22) Filed: Apr. 11, 2023

Related U.S. Application Data
(60) Provisional application No. 63/330,293, filed on Apr. 12, 2022.
(60) Provisional application No. 63/330,289, filed on Apr. 12, 2022.

(51) Int. Cl. G06Q 30/018; G06Q 40/03

(52) U.S. Cl. CPC G06Q 30/018; G06Q 40/03

(57) ABSTRACT

An apparatus audits a document(s) by taking in a list of global parameters and their data values and, for each global parameter, checking the parameter's data value against the data value of each local instance (occurrence) of the parameter in a document. The apparatus employs both relative-comparison and reconciliation techniques to automatically resolve certain mismatches and ensure that they indeed do match the value of the global parameter. Structured, hierarchical audit output is then generated to show an overview of the audited document(s) and its statistics, ordered by how well the audit performed, with the option to click into individual document to see color-coded, informative results on each data point with hyperlinks back to the document.

### CROSS-REFERENCE TO RELATED APPLICATIONS

This application claims the benefit of U.S. Provisional Application No. 63/330,289, filed Apr. 12, 2022, and of U.S. Provisional Application No. 63/330,293, filed Apr. 12, 2022, each of which is incorporated herein in its entirety.

### TECHNICAL FIELD

The present disclosure relates generally to the automated method and system for auditing electronic representation of documents. More particularly, the present disclosure relates generally to the automated method and system for checking whether an electronic representation of a document has any instances in which a particular parameter has an incorrect data value.

### BACKGROUND OF THE INVENTION

Certain applications are very document driven and require many hours of manual review to confirm document accuracy. Invoice processing and mortgage loan processing are just two examples of such applications. For instance, mortgage loan documents may include a single part (form) or multiple parts (forms) having various data fields (e.g., borrower's name, address, telephone number, loan amount, interest rate, etc.) Some of the data fields may be repeated many times on a single form, such as the name and address on a federal W-2 form, while other data fields may repeat on more than one form in a document (e.g., an address field on a W-2 form, URLA, and on a loan application intake form). Because human operators often make mistakes during data entry, some filled-in data fields may include wrong or inconsistent information. For example, an address field entered with six consecutive digits for a zip code could indicate incorrectly entered zip code data. As another example, one address field might use the term “Avenue,” while another, supposedly duplicate address field, might use the term “Street” or “Ave. As a result, there are often many versions of critical documents that relate to a loan transaction and potentially thousands of data fields that need to be analyzed and reconciled to verify that the loan is consistent and to understand the loan's final terms. These tasks have historically been very manual and time-sensitive and are a large part of the reason that the average time to obtain a residential loan is 30-40 days, and sometimes even longer. Moreover, even after such manual reviews, mortgage loans might close with some of these errors or inconsistencies present in the final loan documents. Thus, prior art processes are insufficient for today's digital-age environment, in which data accuracy, speed, and costs are of utmost importance.

On the other hands, such repetitive work can lend itself well to automated processes using robotic process automation (“RPA”) combined with intelligent process automation. RPA uses machines (e.g., software, hardware, or combination of both) to handle tasks in digital domain. RPA is process driven and is domain agnostic. On the other hand, intelligent process automation (“IA”) combines artificial intelligence, machine learning, and process automation to create smart processes (e.g., business processes) and workflows that think, learn, and adapt. Because IA requires understanding of complex processes, preferably, it is domain specific.

For example, in invoice processing domain, RPA and IA could be combined into an automated process for analyzing critical invoicing parameters (e.g., fields) of electronic instantiated invoices in the system or to reconcile invoicing information with a purchase order database. Similarly, in mortgage and loan processing, critical loan parameters in the documents could be analyzed for accuracy and their information can be reconciled.

Accordingly, a method is needed for automatic analysis and reconciliation of a document concerning critical parameters in a fast and cost-effective fashion.

What is also needed is a method for automatic analysis and reconciliation of a loan document concerning critical loan parameters in a fast and cost-effective fashion.

Accordingly, a system is needed that automatically analyzes and reconciles a document concerning critical parameters in a fast and cost-effective fashion.

What is also needed is a system that automatic analyzes and reconciles a loan document concerning critical loan parameters in a fast and cost-effective fashion.

### SUMMARY OF THE INVENTION

The invention provides a method and system for automated analysis and reconciliation of documents, e.g., mortgage loan documents.

In seeking to accelerate aspects of lending, including mortgage preparation, processing, analysis, funding due diligence, underwriting, underwriter auditing, and securitization, it is incumbent upon the mortgage lender, insurer, servicer, etc. to be able to distill all the various document representations of a loan into some global assertions (parameters), or loan terms, and then audit instances of those critical parameters in the actual loan packet. This distillation is usually done using a loan origination system (“LOS”) throughout the loan origination process, and these parameters can be outputted into various electronic data formats. These loan-specific values contained in such electronic data files are critical data points about the loan that should remain consistent, for a given point in time during the lending process or post-close, across all the various forms and documents that comprise the loan, including, for example, URLA, mobile-captured paystubs and W-2s within the loan packet. The data values of these parameters are selected as critical based on their relevance to the mortgage decision-making process. Internal consistency of the data values of these parameters across the loan document and its electronic representations (e.g., borrower names and addresses, property address, income assertions, loan interest rate, loan amount, etc.) are essential to ensure that a loan is legitimate and can be properly evaluated and securitized. Thus, a part of loan origination process, loan origination systems (“LOS”) may identify a set of parameters that are considered by the loan originator to be critical parameters.

The invented system takes the loan document file, after all requisite document processing and optional human validation have been completed and intakes an electronic data file that contains representations of essential loan parameters and their data values. The data file may be referred to as a list of global parameters. The invention then processes an electronic representation of the document being audited, to extract (identify) all instances of local parameters (data fields) in the document. The electronic document file could be any known file format, such as the formats carrying the following suffixes: “.pdf”, “.txt”, “.xml”, etc. The global parameters list (file)

could also be in different formats, including the “.json” suffixed format. The invention then maps each global parameter to its corresponding extracted local parameter(s) in the document, to create a global-parameter-to-local-parameter(s) mapping. Based on the extracted information, for each global parameter, data value of the global parameters is then matched against all local instances (occurrences) of the corresponding local parameters within the loan document. The matching is accomplished in two phases. The first phase uses a relative-comparison matching technique(s) and the second phase uses reconciliation technique(s), which involve more powerful and rigorous checking. If the global data value consistently matches all data values of the local instances of the parameter in question, then that data value, or loan attribute, passes the audit check with no warnings and no requirement for further human analysis. If each local occurrence of a given parameter is not consistent within the loan packet and provided that a solution cannot be found for a way to reconcile data variations for the parameter, a mismatch result is presented with additional trace information for review purposes.

The invention incorporates a suite of relative-comparison and reconciliation methods that can take a data value that doesn't match and try to automatically ascertain if it can still be considered a match. Such reconciliation methods can turn mismatches into matches without requiring a human-in-the-loop (HITL) to validate correctness. These methods use business logic and the source documents, along with other automatic checks and conditions to override a mismatch and definitively prove that the local instance of the global parameter in question is indeed represented correctly.

In one embodiment, the relative-comparison phase is sufficient to confirm that a particular local instance of a parameter qualifies as an overall match, thus removing the need for performing a reconciliation phase on the local instance.

In another embodiment, to constitute an overall match, each of the relative-comparison phase and the reconciliation phase must produce a match of the local instance.

The invention is not limited to analyzing a single document, such as a single loan packet, but can be used to analyze a pool (batch) of loans. This may be useful in situations where a mortgagee wants to sell a batch of loans to investors on a secondary market. Accordingly, the invented method can be applied to a group of documents, e.g., pool of loans.

Once the invented system processes the document or a batch of documents, it outputs an audit result in a form of a digital file. The output file may be in many different formats, such as web-based graphical user interface (web-based GUI), Excel, CSV (Comma Separated Values), etc. An overall output may serve as the main digest. For example, for loan documents, the digest may include a loan-per-row set of resultant statistics. In one embodiment, the resultant statistics may include, for each identified global parameter, the number of local instances of the parameter, the number of matches pre- and post-reconciliation, match percentages pre- and post-reconciliation, etc.), in a predetermined order. In cases where the audit output is presented in a spread sheet form, the spread sheet may include hyperlinks to allow a user to view several types of loan specific outputs, as well as the original image of the source document in question. Loan specific audit output files may be structured and color-coded to be easily read and understood by the user. They may also include data on each global parameter and its corresponding match locations throughout the loan documents, with hyperlinks to specific parts of the source documents for further verification and auditing purposes.

A similar audit output may be presented in a non-spreadsheet form, e.g., in a CSV format. In addition, some CSVs may allow outputting information on every mismatch in each row, general overall statistics, and a text file showing the system execution time.

The invention can be implemented as a set of executable instructions stored in a memory device that when executed by a processor, practice the invented method. The memory may be local or it may be cloud based. Execution of the instructions can be performed by a server.

In one embodiment, the invented document auditing method includes: receiving an electronic representation of a document; receiving a parameter list comprising a global parameter and a global data value of the global parameter; extracting a set of local parameters from the electronic representation; from the set of local parameters, identifying each local parameter corresponding to the global parameter; for each identified local parameter: (i) performing a relative comparison of a data value of the respective local parameter to the data value of the global parameter, and (ii) upon the relative comparison resulting in a mismatch, performing a parameter reconciliation process; and outputting an audit-result output.

In one embodiment, the invention includes a non-volatile memory comprising instructions that, when executed by a processor, perform operations comprising: receiving an electronic representation of a document; receiving a parameter list comprising a global parameter and a global data value of the global parameter; extracting a set of local parameters from the electronic representation; from the set of local parameters, identifying each local parameter corresponding to the global parameter; for each identified local parameter: (i) performing a relative comparison of a data value of the respective local parameter to the data value of the global parameter, and (ii) upon the relative comparison resulting in a mismatch, performing a parameter reconciliation process; and outputting an audit-result output.

In one embodiment of the invention, the audit-result output lists the number of times the parameter reconciliation process resulted in failure.

In one embodiment of the invention, the relative comparison step comprises performing an exact-string comparison.

In one embodiment of the invention, the relative comparison step comprises performing an alias-string comparison.

In one embodiment of the invention, the parameter reconciliation process comprises using a context-dependent deductive reasoning matching process.

In one embodiment of the invention, the parameter reconciliation process comprises using an optical-character-recognition dependent matching.

In one embodiment of the invention, the parameter reconciliation process comprises using a configuration dependent matching, which could be set by either a user or a developer.

In one embodiment of the invention, the document is a loan document.

In one embodiment of the invention, the document is a single loan document (e.g., a form) or a collection of loan documents, which can also be referred to as a loan. In one embodiment, the invention can process a larger collection of multiple loans, each comprising of collections of loan documents, which can also be referred to as a “batch.”

### BRIEF DESCRIPTION OF DRAWINGS

The illustrated embodiments of the subject matter will be best understood by reference to the drawings, wherein like parts may be designated by like numerals throughout. The following description is intended only by way of example, and simply illustrates certain selected embodiments of devices, systems, and processes that are consistent with the subject matter as claimed herein.

FIG. 1 illustrates a sample document that can be processed by the present invention.

FIG. 2 shows a method according to an embodiment of the invention.

FIG. 3 shows a global parameter list according to an embodiment of the invention.

FIG. 4 conceptually shows a relative-comparison phase according to an embodiment of the present invention.

FIG. 5 conceptually shows a reconciliation phase according to an embodiment of the present invention.

FIG. 6 illustrates an audit-result output according to an embodiment of the invention.

FIG. 7 shows a server according to an embodiment of the present invention.

FIG. 8 shows a cloud-based system according to an embodiment of the present invention.

### DETAILED DESCRIPTION OF THE INVENTION

The present invention provides for a method and a system for automated auditing of electronic documents. The documents may include a single part (form) or multiple parts (forms) having various data fields (e.g., borrower's name, address, telephone number, loan amount, interest rate, etc.). Some of the data fields (parameters) may be repeated many times on a single form, such as the name and address on a federal W-2 form, while other data fields (parameters) may repeat on more than one form in a document (e.g., an address field on a W-2 form and on a loan application intake form or on a disclosure form).

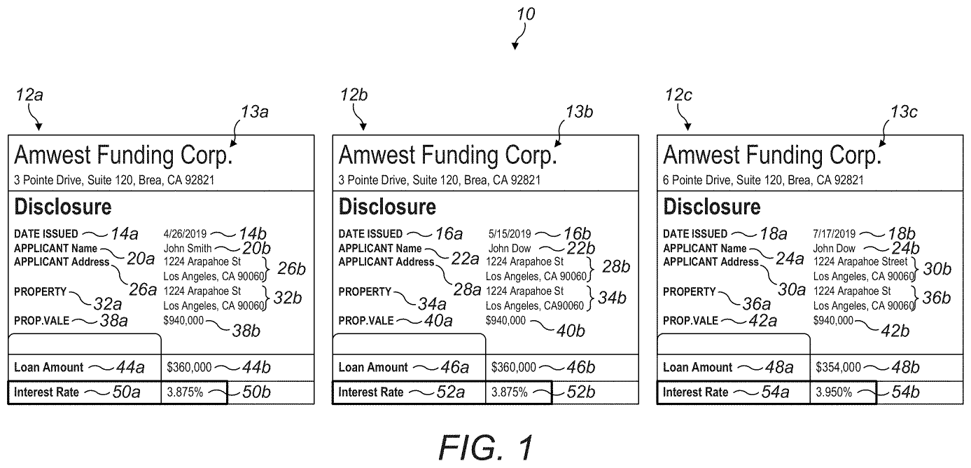

FIG. 1 illustrates a sample document, Ref. 10, that can be processed by the present invention. For simplification, the document 10 in FIG. 1 is shown as having three versions of the same disclosure form, 12a, 12b, and 12c, issued by the Amwest Funding Crop. (See Refs. 13a, 13b, and 13c. Each form version has various local fields (local parameters). In particular, each disclosure form 12a, 12b, and 12c includes its own: “DATE ISSUED” parameter (references 14a, 16a, and 18a, respectively); “APPLICANT Name” parameter (references 20a, 22a, and 24a, respectively); “APPLICANT Address” parameter (references 26a, 28a, and 30a, respectively); a “PROPERTY” parameter (references 32a, 34a, and 36a, respectively); “PROP. VALUE” parameter (references 38a, 40a, and 42a, respectively); “Loan Amount” parameter (references 44a, 46a, and 48a, respectively); and “Interest Rate” parameter (references 50a, 52a, and 54a, respectively). Thus, document 10 is shown as having twenty-one local parameters, with each individual local parameter having its own data value.

Specifically in form 12a, the local “DATE ISSUED” parameter 14a has a data value of “4/26/2019” (Ref. 14b); the local “APPLICANT Name” parameter 20a has a data value of “John Smith” (Ref. 20b); the local “APPLICANT Address” parameter 26a has a data value of “1224 Arapahoe Street Los Angeles, CA 90060” (Ref. 26b) spread across two lines; the local “PROPERTY” parameter 32a has a data value of “1224 Arapahoe Street Los Angeles, CA 90060” (Ref. 32b) spread across two lines; the local “Loan Amount” parameter 44a has a data value of “$360,000” (Ref. 44b); and the local “Interest Rate” parameter 50a has a data value of “$3.875%” (Ref. 50b).

In form 12b, the local “DATE ISSUED” parameter 16a has a data value of “5/15/2019” (Ref. 16b); the local “APPLICANT Name” parameter 22a has a data value of “John Dow” (Ref. 22b); the local “APPLICANT Address” parameter 28a has a data value of “1224 Arapahoe Street Los Angeles, CA 90060” (Ref. 28b) spread across two lines; the local “PROPERTY” parameter 40a has a data value of “1224 Arapahoe Street Los Angeles, CA 90060” (Ref. 40b) spread across two lines; the local “Loan Amount” parameter 46a has a data value of “$360,000” (Ref. 46b); and the local “Interest Rate” parameter 52a has a data value of “$3.875%” (Ref. 52b).

Finally, in form 12c, the local “DATE ISSUED” parameter 18a has a data value of “7/17/2019” (Ref. 18b); the local “APPLICANT Name” parameter 24a has a data value of “John Smith” (Ref. 24b); the local “APPLICANT Address” parameter 30a has a data value of “1224 Arapahoe St. Los Angeles, CA 90060” (Ref. 30b) spread across two lines; the local “PROPERTY” parameter 36a has a data value of “1224 Arapahoe St. Los Angeles, CA 9006” (Ref. 36b) spread across two lines; the local “Loan Amount” parameter 48a has a data value of “$354,000” (Ref. 48b); and the local “Interest Rate” parameter 54a has a data value of “$3.950%” (Ref. 54b).

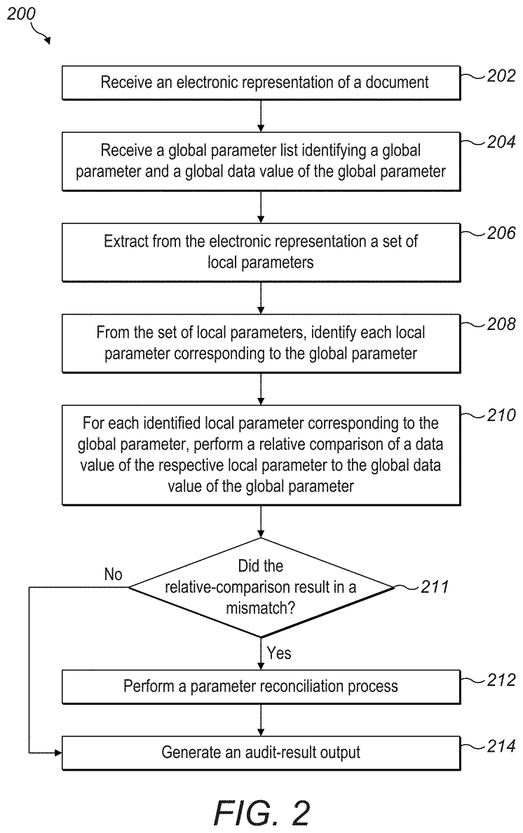

Because the local “DATE ISSUED” parameters in the three forms have three different data values, representing different dates, Reference 12a designates as an initial version of the form, Reference 12b designates as an intermediate version of the form, and Reference 12c designates as a final version of the form. (Because on each form version the “APPLICANT Address” and “PROPERTY” parameters have the same data values, this may signify that document 10 relates to a refinance loan.) Document 10 may be audited via a method disclosed in FIG. 2.

FIG. 2 discloses a document auditing method 200 according to an embodiment of the invention. The method includes receiving an electronic representation of a document (step 202), e.g., document 10 of FIG. 1 or a batch of documents, and also receiving a global parameter list (step 204). The global parameter list received in step 204 identifies (lists) at least one global parameter per document and, for each identified global parameter, provides a corresponding global data value of the parameter.

At step 206 the method proceeds to extract (identify) all the local parameters from the received electronic representation of the document. For example, with reference to document 10 in FIG. 1, each of the “DATE ISSUED” (Refs. 14a, 16a, and 18a), “APPLICANT Name” (Refs. 20a, 22a, and 24a), “APPLICANT Address” (Refs. 26a, 28a, and 30a), “PROPERTY” (Refs. 32a, 34a, and 36a), “PROP. VALUE” (Refs. 38a, 40a, and 42a), “Loan Amount” (Refs. 44a, 46a, and 48a), and “Interests Rate” (Refs. 50a, 52a, and 54a) parameters on the three forms would be extracted.

It should be noted that steps 202 and 204 may be performed in any order. Moreover, the two steps could be implemented as a single step. Furthermore, the order of steps 204 and 206 could be reversed.

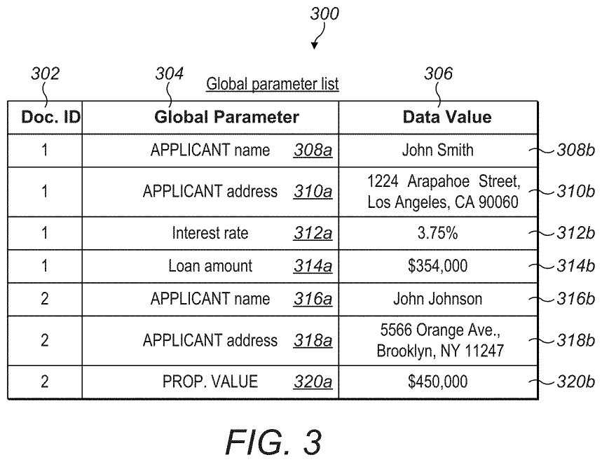

Next, at step 208, for each global parameter in the received global parameter list, corresponding local parameters are identified from all the extracted local parameters. In other words, for each identified global parameter, a subset comprising corresponding local parameters is created from the set of extracted local parameters. This process is described below, with reference to a sample global parameter list shown in FIG. 3.

The global parameter list 300 in FIG. 3 is shown as identifying global parameters and their respective global data values. The list 300 is illustrated as conceptually having three columns, a “Doc. ID” column 302, a “Global Parameter” column 304, and a “Data Value” column 306. The “Doc. ID” column 302 identifies the document to be audited. In the illustrated example, the “Doc. ID” column lists two separate document IDs, “1” and “2,” which means that the list 300 pertains to a batch comprising two documents, which are to be separately audited. Not only may the numbers of global parameters for each document be different, but the global parameters themselves identified for separate documents may differ. For example, concerning the document having document ID of “1,” the list 300 identifies four global parameters, “APPLICANT Name” (Ref. 308a), “APPLICANT Address” (Ref. 310a), “Interest Rate” (Ref. 312a), and “Loan Amount” (Ref. 314a), each of which has its own corresponding data value, designated by Refs. 308b, 310b, 312b, and 314b, respectively. At the same time, regarding the document having document ID of “2,” the list identifies only three global parameters, “APPLICANT Name” (Ref. 316a), “APPLICANT Address” (Ref. 318a), and “PROP. VALUE” (Ref. 320a), each with its own corresponding data value, designated by Refs. 316b, 318b, and 320b, respectively. Thus, the global parameter lists may require that one document be audited for one set of global parameters while the other document in the batch be audited for another set of global parameters.

The foregoing description will assume that the Doc. ID of “1” in the list 300 identifies document 10 of FIG. 1. As a result, in step 206 of FIG. 2, a set of twenty-one local parameters (seven local parameters from each form 12a, 12b, and 12c) would be extracted from the document 10.

In step 208, however, for each of the four global parameters 308a, 310a, 312a, and 314a, a subset of three corresponding local parameters would be identified for auditing purposes. Specifically, for global “APPLICANT Name” parameter 308a, only the local “APPLICANT Name” parameters (Refs. 14a, 16a, and 18a) would be identified; for global parameter “APPLICANT Address” 310a, only the local “APPLICANT Address” parameters (Refs. 26a, 28a, and 30a) would be identified; for global “Interest Rate” parameter 312a, only the local “Interest Rate” parameters (Refs. 50a, 52a, and 54a) would be identified; and for global “Loan Amount” parameter, only the local “Interest Rate” parameters (Refs. 44a, 46a, and 48a) would be identified. (Note, while in the above description the field names of the corresponding local parameters are the same as the name of the global parameter in question, e.g., for the global “APPLICANT Name” parameter 308a, all three corresponding local parameters at references 20a, 22a, and 24a are also called “APPLICANT Name,” the corresponding local parameters could be called differently on different forms. For example, one or more local parameters corresponding to the global “APPLICANT Name” parameter could be called “Borrower,” “Applicant,” etc. Regardless, the invented system can identify the corresponding local parameters for each global parameter in question.) Thus, in step 208, the invention identifies a subset of extracted local parameters for each global parameter. If the global parameter list includes just one global parameter, a single subset of the corresponding local parameters would be identified.

In step 210, for each identified local parameter corresponding the global parameter in question, the method performs a relative comparison of the local data value to the global data value. For example, the global “APPLICANT Name” parameter (Ref. 308a) has a value “John Smith” (Ref. 308b). As explained above, for this global parameter, in step 208, three corresponding local “APPLICANT Name” parameters, Refs. 20a, 22a, and 24a, are identified. Then, step 210 is performed for each of these three local parameters.

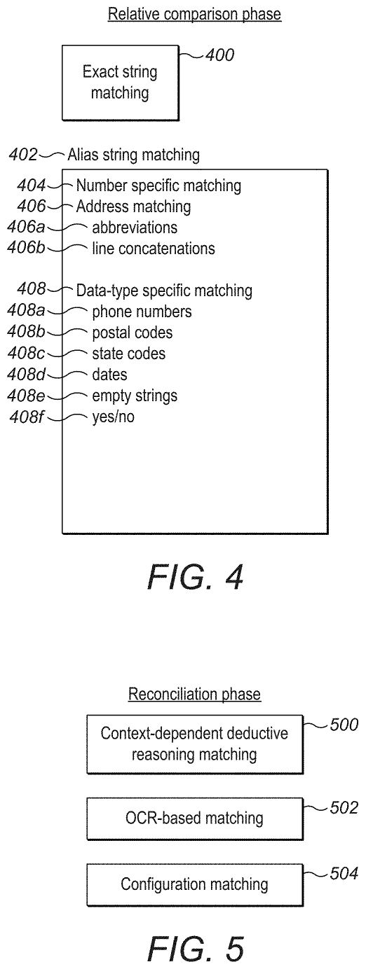

The relative comparison step 210 constitutes a first matching stage of the invented method. This matching phase involves matching based on alphanumeric character string comparison(s). The various exampling character string comparisons according to the invention are disclosed in more detail with reference to FIG. 4.

FIG. 4 shows examples of relative-comparison phase of the present invention. One embodiment of the relative comparison phase uses exact string matching, Ref. 400. For example, the local “APPLICANT Name” parameter 20a, in the initial form version 12a, has a local data value “John Smith” (Ref. 20b). Doing relative comparison using exact string matching 400 would compare the local string “John Smith” 20b (FIG. 1) with the global string “John Smith” 308b (FIG. 3). Because these two strings are identical, the relative comparison would produce a match. A similar matching result would be produced when performing exact string matching 400 on the data value of local “APPLICANT Name” parameter 24a, in the final form version 12c.

The relative comparison phase may also use alias string matching, ref. 402. This type of relative comparison checks for possible equivalents between the local and global values of the respective local and global parameters (field). As a result, it can account for format variations and aberrations in local data values. In one embodiment, the invention may also account for formal variations and aberrations in global data values.

For example, alias string matching can use a number-specific matching process, Ref. 404, which accounts for various ways the same number could be expressed. For example, number-specific matching 404 would match the integer form of “5” with its floating-point equivalent “5.0”. This may also include numerical rounding, with an acceptable range of differences for specific parameters.

Address matching, Ref. 406 is another type of alias string matching, and itself could include two separate matching processes, matching abbreviations 406(a) and matching line concatenations 406(b). Each is explained separately below.

Addresses often incorporate accepted abbreviations for things like street suffixes, secondary designations (such as apartment or suite identifiers), or even street names. Therefore, abbreviation type address matching 406(a) can treat such abbreviations and identifiers as equivalents. For example, each of the following strings could be treated as equivalents: “Street” and “St.”; “Apartment” and “Apt.” or “Unit” or “Suite”; “Avenue” and “Ave.”; etc. In other words, a known equivalent abbreviation or identifier of a string in an address field would still result in a match. This can be seen by looking at the local “APPLICANT Address” parameters (Refs. 26a, 28a, and 30a in FIG. 1). The corresponding global “APPLICANT Address” parameter, Ref. 310a, has a data value
“1224 Arapahoe Street
Los Angeles, CA 90060 (Ref. 310b).

Each of the local “APPLICANT Address” parameters 26a and 28a has a data value 26b and 28b, respectively, that is identical to the global data value Ref. 310b. Accordingly, doing exact string matching 400 against the global data value 310b would be sufficient to produce a match for each of the two local “APPLICANT Address” parameters 26a and 26b. Applying exact string matching 400 to the local “APPLICANT Address” parameter Ref. 30a, in final version form 12c, however, would result in a mismatch. That is because data value 30b of the local “APPLICANT Address” parameter Ref. 30a uses a “St.” abbreviation for the string “Street”. Applying the abbreviation type address matching 406(a), however, would account for such an abbreviation and would result in a match.

Another address related accounting that might be required is a line-concatenations adjustment. Addresses on a form are often split between two lines, with the first line listing the physical/street address and the second line listing any secondary designations for the address. Knowing that the separation between the two address-related lines is merely a formatting variation, line-concatenating address matching process can account for the variation, by concatenating the two line together with any appropriate delimiters, and result in a match.

Another example of alias string matching involves data type specific matching 408, where data values of specific type of parameters have multiple ways being represented. Although they may be equivalent, these data values would fail the exact-string matching process. Appropriate parsing can be performed to accurately match data values of these parameters against the way that the data value is canonically represented in the document. This can be applied to phone number related parameters, Reg. 408(a), where phone number strings can be expressed in many different formats. For example, a telephone number may be expressed as a string of digits only, such as “6462224679.” The same telephone number could be also expressed as “(646) 222-4679”, “646-222-4679”, etc., each of which would be equivalent.

Data specific matching 408 could also be applied to postal-code related 408b and to state-code related 408c parameters. For example, postal codes are sometimes expressed as a series of five digits that are followed by a hyphen and several more digits or alphanumeric characters. As long as the first five digits in the two postal code strings match, the alias string matching of postal-code related parameters would result in a positive match.

Data specific matching 408 could also be applied to date-related parameters 408d. For example, the date expressed as a data parameter string “7/17/2019” can also be expressed as “July 17, 2019”, “7-17-2019”, “Seventeen, July 2019”, etc., each of these would be considered an equivalent and would produce a matching result for date-related parameters.

Data specific matching 408 could also be applied to empty strings (Ref. 408e), i.e., a parameter whose data value his empty. An equivalent for such an empty string could be any one of the following strings” “0”, “0.00”, “N/A”.

Data specific matching 408 could also be applied to parameters involving “Yes” or “No” confirmations, Ref. 408f. For such parameters, a “0” string, a “False” string, and/or even an empty string, may be considered equivalent to a “No” string. Correspondingly, a “1” string and/or a “True” string may be considered equivalent to a “Yes” string.

As can be understood by one of ordinary skill in the art, alias-string matching 402 is not limited to the examples provided above but may cover other processes that account for format variations and aberrations in parameters' data values.

The relative comparison step 210 may include exact-string matching 400 only or as explained above with reference to FIG. 4, it may include both exact-string matching 400 and alias-string matching 500.

Returning to FIG. 2, the relative-comparison step 210 is followed by a logical decision 211. Specifically, if the relative comparison step 210 for a particular local parameter produces a match, the method proceeds to step 214, to generate an audit-result output concerning the local parameter. Otherwise, if the relative-comparison step 210 results in a mismatch, the method proceeds to step 212, during which a reconciliation for the local parameter is attempted.

Reconciliation phase involves more rigorous and powerful automated checking mechanisms that look deeper within the document. For example, to ascertain whether there is an actual mismatch when compared to the value of the global parameter, the checking mechanisms may consider a specific form in which the local parameter is located, importance of the specific form to the veracity of the document, calculation process of the local data value, the context of local data value within the document, and parameter attributes (characteristics). These mechanisms can overturn a failed match to determine with a given degree of certainty that the local data value in question should indeed be considered as a match for the corresponding global data value. These mechanisms can also correct for errors due to technology, while maintaining the accuracy of the local data values on a document page. As result, while a legitimately error-free document would pass an audit without mismatches, actual errors in the document would be identified.

FIG. 5 conceptually shows a reconciliation phase according to an embodiment of the present invention. The reconciliation step 212 may employ one or more of the reconciliation processes identified in FIG. 5. For example, the reconciliation step 212 may employ matching that involves context-dependent deductive reasoning. This type of reconciliation relies on logical analysis of mismatch situations that attempt to discern a viable and provable basis for overturning the initial mismatch from step 210. These processes check multiple conditions of a mismatch, such as its context and the degree of the mismatch, and may check whether it might match some other similar parameter. The processes then determine whether it is likely that the mismatch appeared due to a clear, well-known, and understood reason. The checks may include assessing document author's, e.g., applicant's/co-applicant's, possible confusion in filling out the forms, form changes, importance of the local parameter's presence or absence, acceptable deviations in local data values, estimations, unordered field matching, etc.

One example of a context-dependent deductive reasoning process is versioning. If a system determines that a local data value of a local parameter is associated with a non-final version of a document form, and if the local parameter may be a type whose value could change overtime, the system may reconcile this local data value as either a match or a partial match, e.g., a match with an associated warning. Following are two examples of applying a context-dependent deductive reasoning process to the document in FIG. 1. In the first example, we will look at the local “APPLICANT Name” parameter 22a, which has a data value of “John Doe” (Ref. 22b), and in the second example at the local “Interest Rate” parameter 52a, which has a data value of 3.875% (Ref. 52b). Given that the global “APPLICANT Name” parameter 308a (FIG. 3) has a data value of “John Smith” (Ref. 308b) and the global “Interest Rate” parameter has a data value of “3.95%”, performing a relative comparison 210 on each of these local parameters would result in two separate mismatches. Thus, in each case, the method would proceed to the reconciliation step 212.

As a preliminary matter, the system evaluates the three “Disclosure” forms 12a, 12b, and 12c and determines that their respective local “DATE ISSUED” parameters have different values, from the earliest, 4/26/2019 (Ref. 14b), to intermediate 5/15/2019 (Ref. 16b), to the latest 7/17/2019 (Ref. 18b). Understanding the context of the three disclosure forms, the system can deduce that form 12b is an intermediate version of the disclosure. As a result, both local parameters “APPLICANT Name” parameter 22a and “Interest Rate” parameter 52a are analyzed in an “intermediate” context of the loan application process. Versioning determination may also be made based on other features in the document, such as presence or absence of signatures, multiple other date fields, presence of certain clerical check marks, etc.

Thus, the reconciliation is attempted between the local data value “John Dow” of the local parameter “APPLICANT Name” and the data value “John Smith” of the global parameter “APPLICANT Name” in the intermediate context. In this case, however, the system understands that the name of the applicant should not change during loan application. In other words, the local “APPLICANT Name” parameter should be static. As a result, in this case, despite being analyzed in the intermediate context, the context-based deductive reasoning reconciliation method would produce a mismatch with a warning. However, if the, value “John Dow” of the local “APPLICANT Name” (FIG. 1, Ref. 24b) parameter in the final version of the document did not match the global value “John Smith” of the “APPLICANT Name” parameter, then the system would produce a full mismatch.

Applying the same approach to the local “Interest Rate” parameter, however, could produce a different result. Specifically, the reconciliation is attempted between the local data value “3.875%” of the local parameter “Interest Rate” and the data value “3.95%” of the global parameter “Interest Rate” in the intermediate context. In this case, the system understands that certain parameters, such as interest rate, may change during the loan application process. In other words, the system understands that certain parameters may be dynamic. Accordingly, analyzing the local “Interest Rate” parameter 52a as a dynamic parameter in the intermediate context will result in overcoming the mismatch from the relative comparison step. In such a situation, an audit-output could be either a match, or a warning, as opposed to a full mismatch.

The reconciliation step 212 may also employ matching that involves optical-character-recognition-based (“OCR-based”) matching 502. In this matching method, the system processed the original OCR document streams by searching, scraping, and manipulating the streams to identify the presence of global data values locally, while taking appropriate precautions to have tight methodologies so as not to allow false positives to pass through. For example, if an improper or even an empty value for a local parameter is extracted, thereby resulting in the relative-comparison operation producing a mismatch, the OCR-based matching could scrape for the global value of the corresponding global parameter inside a raw OCR stream of the document to locate and ascertain the presence of the proper local value. If the global value is sufficiently unique and the aforementioned conditions are met, the OCR-reconciliation process returns a full match. This type of reconciliation method may take into account the specifics characteristics, e.g., weaknesses of a particular OCR engine. This can allow the system to understand where the OCR engine made a clear mistake to correct for it, again with proper safeguards for false positives. For example, at a particular scanning resolution, an OCR engine might interpret a combination of letters “ri” as a single letter “n”. Knowing this weakness of the OCR engine, might allow the system to correct for such an error during an audit. OCR-based matching may also process OCR strings to remove from a string any non-alphanumeric characters, such as spaces, commas, tabs, etc. OCR-based matching may also search for different parts of a string, limit the search to a portion of a document where the local string is expected to be located. OCR-based matching may employ OCR searching using multiple different OCR engines.

The reconciliation step 212 may also employ matching that involves configuration matching 504. Here, the system may be programmed to ignore specific mismatches in certain local parameters, ignore certain global parameters, ignore redactions, account for change of form formats, etc. For example, the system might be programmed to ignore a mismatch in the local “APPLICANT Name” parameter if the mismatch is based on the middle-name part of the local data value, because the middle name might not be critical for a particular use-case of the invention.

In step 214 the invented method generated an audit-result output. Although the audit-result output in step 212 is shown as pertaining to a result of matching a single instance of a local parameter, because the global parameter list may require auditing a document for more than one global parameter, and because each global parameter can correspond to more than one instance of a local parameter in the document, steps 208 through 212 are performed for each instance of the local parameter. Accordingly, step 214 applies to an overall audit-result for the document.

Once the invented system processes the document or a batch of documents, it outputs an audit result in a form of a digital file. This is shown in step 214 in FIG. 2. The output file may be in many different formats, such as Excel, CSV, etc. An audit result output may serve as the main digest for an audited single loan document, a single loan, or a batch of loans. For example, for loan documents, the digest may include a loan-per-row set of resultant statistics. In one embodiment, the resultant statistics may include, for each identified global parameter, the number of local instances of the parameter, the number of matches pre- and post-reconciliation, match percentages pre- and post-reconciliation, etc.), in a predetermined order. In cases where the audit output is presented in a spread sheet form, the spread sheet may include hyperlinks to allow a user to view several types of loan specific outputs, as well as the original image of the source document in question. Loan specific audit output files may be structured and color-coded to be easily read and understood by the user. They may also include data on each global parameter and its corresponding match locations throughout the loan documents, with hyperlinks to specific parts of the source documents for further verification and auditing purposes.

A similar audit output may be presented in a non-spreadsheet form, e.g., in a CSV format. In addition, some CSVs may allow outputting information on every mismatch in each row, general overall statistics, and a text file showing the system execution time. Alternatively, it could be represented in a web-based GUI, which may include a log in feature, and be a more interactive, seamless, and customizable form of output.

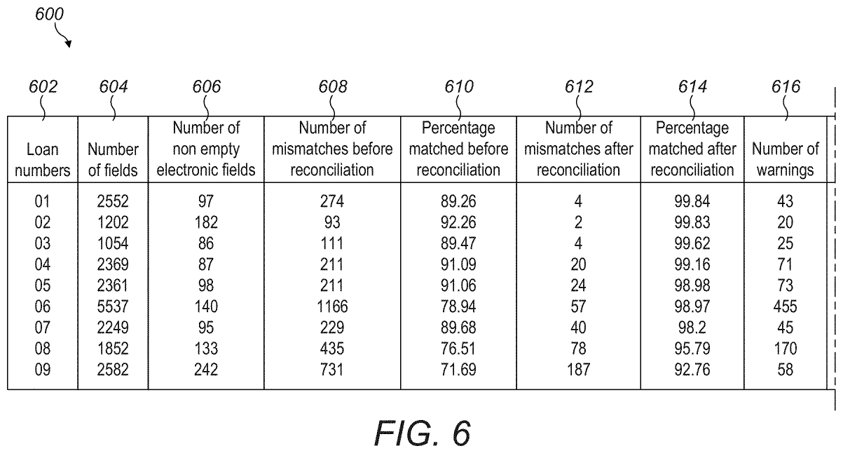

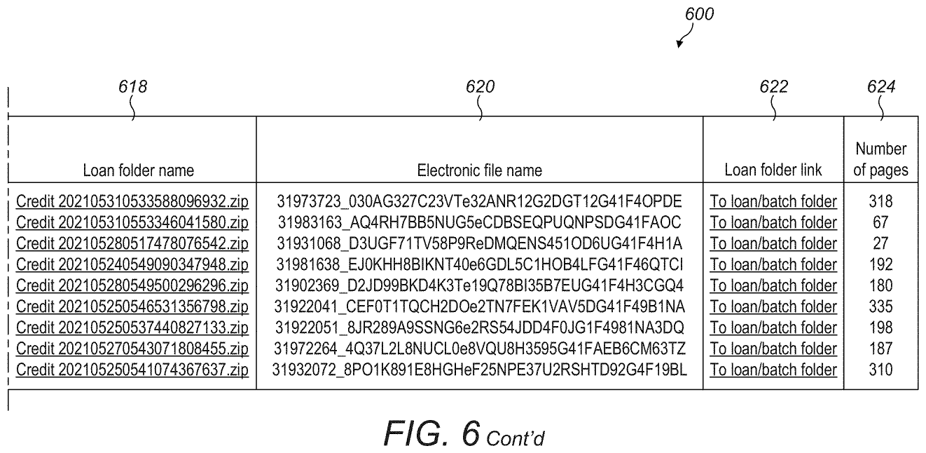

FIG. 6 illustrates an audit-result output according to an embodiment of the invention. In FIG. 6, the audit-result file 600 is presented as a spread sheet with audit results digest for nine separate loans, each row providing audit statistics for one corresponding loan. The spread sheet 600 includes twelve columns.

The leftmost column (Ref. 602) identifies the loan document, e.g., “01.” Each loan identifier may also be local hyperlink to the particular loan's specific loan-results sheet.

The next column, Ref. 604, lists the number of local parameters (fields) that were extracted from the loan document. As can be seen, for loan “01,” a total of 2552 local parameters were extracted.

The next column (Ref. 606) lists the number of local parameters with non-empty data values. For loan No. “01,” that number is 97.

The next column (Ref. 608) lists the number of mismatches that were identified during the relative-comparison stage, prior to reconciliation. Depending on the embodiment of relative comparison step, this could have been based on the exact-string matching method only, or on the combination of both exact-string and alias-string matching processes. For loan No. “01,” that number is 274. Moreover, the results of each of the exact-string matching and alias-string matching processes of the relative-comparison step could be outputted in their own respective output column.

The next column (Ref. 610) lists the percentage of local data values that resulted in a match during the relative comparison stage. For loan No. “01,” that percentage is 89.26%.

The next column (Ref. 612) lists the number of mismatches remaining even after reconciliation. This column may also serve as a hyperlink to the loan's specific output for just mismatches. For loan No. “01,” that number is 4.

The next column (Ref. 614) lists the percentage of local data values that resulted in a match after the reconciliation stage. For loan No. “01,” that percentage is 99.84%.

In addition to a binary “match” v. “mismatch” result for evaluated local parameter, the system could also include a third, “warning” option. This option may be used to designate a weaker form of matching, which may warrant a manual review of the loan document. Column 616 provides such an indication for each audited loan document. For loan No. “01,” that number is 43. Note, the present invention it not limited to any particular number warning types or levels, and other implementations, such as having a “match with warning” label, are within the scope of the invention.

The next column (Ref. 618) identifies the loan folder name from the input set. This column may also provide a hyperlink to the specifics of audit-result file for a particular loan. The loan-specific result file may provide specifics concerning each local parameter (the content, location, etc.), an audit result for each local parameter (in graphical or color form), details of any matching process(s) associated with the local parameter, system comments, a link to the actual image of the local parameter on a page of the loan document, visually designating (in the image), the local value in question, etc.

The next column (Ref. 620) in FIG. 6 lists the names of electronic data files for the respective loans that were used to obtain each loan's local parameters.

The next column (Ref. 622) provides a link to the input files, their extracted local values, and/or their versions included in a loan folder for each loan.

The rightmost column (Re. 624) lists the number of pages included in each respective loan document. For loan “01” that number is 318.

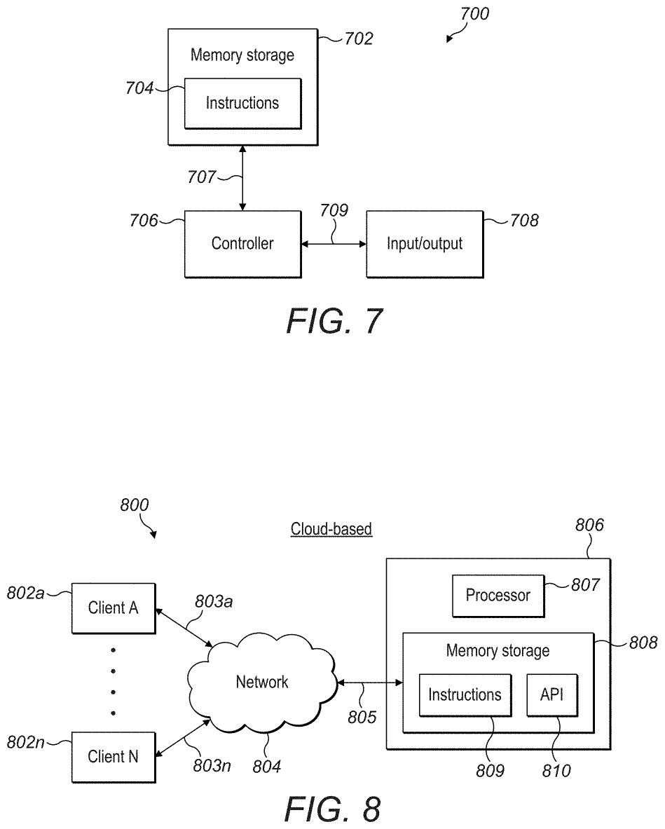

FIG. 7 shows a server implementing the system according to an embodiment of the present invention. The server 700 includes a memory storage (memory) 702 that stores a set of executable instructions 704 for performing the invented automated document auditing process. The memory 702 is coupled to a controller (e.g., processor or microprocessor) 706 via a bidirectional communication channel 707. Input/Output device(s) (“I/O device(s)”) and ports 708, such as a display, keyboard, microphone, speaker, serial port, parallel ports, ethernet port, etc., are coupled to the memory 702 through the controller 706, via an I/O bus 709.

FIG. 8 shows a cloud-based system according to an embodiment of the present invention. The system 800 includes one or more client computers “Client A” (Ref. 802a) through “Client N” (Ref. 802n) communicatively coupled to a server 806 via a network 804. The network can be any type of a local or wide area network, such the Internet. The figure shows each client 802a and 802n coupled to the network 804 via its respective communication link 803a and 803n. The server 806 is coupled to the network 804 via link 805. Each of the links can be any known communication links, wired or wireless. The server 806 is similar to the server 702 in FIG. 7, such that it includes a processor 807 and a memory storage (non-volatile memory) 808. The memory 808 stores a set of executable instructions 809 for performing the invented automated document auditing process when executed by the processor 807. In addition, to be able to communicate audit related information with client computers, server's memory also includes an application processing interface (“API”) 810.

Whether implemented as a local server 700 or as cloud-based system 800, the present invention allows batched documents to be audited in parallel. This can be accomplished by using separate hardware processors, each processing (auditing) a separate document from the document batch. It may also be accomplished by running the auditing program in a virtual-machine environment, in which a single physical processor could emulate the functionality of multiple processors. The invention could also use a containerization method (e.g., using Docker open-source software), known in the art.

The present invention may be implemented in software, hardware, firmware, or their combinations. When implemented in software, programming instructions for the different auditing steps described above may be implemented as separate software modules. The software may then be stored on a server(s), a local computer, a portable memory (e.g., CD, solid state memory, etc.) or it may be downloaded from cloud storage over the Internet. Once the software in the present invention is downloaded onto a server or a computer, a microprocessor inside the server or the computer executes the instructions to audit electronic documents according to the present invention.

When designed in hardware or firmware, the server or the computer may audit electronic documents according to the present invention without any downloading of software code from portable storage or from cloud storage.

In one alternative embodiment, the system for auditing documents according to the present invention may reside remotely (e.g., in the cloud or on a local network), in which case a user would first log into the remote auditing system, present his/her electronic document or a batch of documents to the auditing system and would let the system audit the document remotely. This is generally referred to in the art as a software as a service (“SaaS”) model.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

Because individual structures (implemented in programming instructions, circuits, or their combinations) for performing the various steps of the invented method, such as “receiving,” “obtaining,” “extracting,” “selecting,” “grouping,” “identifying,” “determining,” “comparing,” “applying,” and “adjusting” are known to one skilled in the art, the steps have been disclosed at a logical (flow chart) level only, and further details are not necessary for making and using the invention.

Unless stated otherwise, terms such as “first” and “second” may be used to arbitrarily distinguish between the elements such terms describe. Thus, these terms are not necessarily intended to indicate temporal or other prioritization of such elements.

Unless otherwise stated, conditional terms such as “can,” “could,”, “will,” “might,” or “may” are understood within the context as used in general to convey that certain embodiments include, while other embodiments do not include, certain features and/or elements. Thus, such conditional terms are not generally intended to imply that features and/or elements are in any way required for one or more embodiments.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

1. A document auditing method comprising:
receiving an electronic representation of a document;
receiving a parameter list comprising a global parameter and a global data value of the global parameter;
extracting a set of local parameters from the electronic representation;
from the set of local parameters, identifying each local parameter corresponding to the global parameter;
for each identified local parameter: (i) performing a relative comparison of a data value of the respective local parameter to the data value of the global parameter, and (ii) upon the relative comparison resulting in a mismatch, performing a parameter reconciliation process; and
outputting an audit-result output.

2. The document auditing method of claim 1, wherein the audit-result output lists the number of times the parameter reconciliation process resulted in failure.

3. The document auditing method of claim 1, wherein the relative comparison step comprises performing an exact-string comparison.

4. The document auditing method of claim 3, wherein the relative comparison step comprises an alias-string comparison.

5. The document auditing method of claim 1, wherein the parameter reconciliation process comprises using a context-dependent deductive reasoning matching process.

6. The document auditing method of claim 5, wherein the context-dependent deductive reasoning matching process comprises using a versioning criterion.

7. The document auditing method of claim 1, wherein the parameter reconciliation process comprises using an optical-character-recognition dependent matching.

8. The document auditing method of claim 1, wherein the parameter reconciliation process comprises using a configuration dependent matching.

9. The document auditing method of claim 1, wherein the document is a loan document.

10. The document auditing method of claim 1, wherein the document is a batch of loan documents.

11. A non-volatile memory comprising instructions that, when executed by a processor, perform operations comprising:
receiving an electronic representation of a document;
receiving a parameter list comprising a global parameter and a global data value of the global parameter;
extracting a set of local parameters from the electronic representation;
from the set of local parameters, identifying each local parameter corresponding to the global parameter;
for each identified local parameter: (i) performing a relative comparison of a data value of the respective local parameter to the data value of the global parameter, and (ii) upon the relative comparison resulting in a mismatch, performing a parameter reconciliation process; and
outputting an audit-result output.

12. The non-volatile memory of claim 11, wherein the audit-result output lists the number of times the parameter reconciliation process resulted in failure.

13. The document auditing method of claim 11, wherein the relative comparison step comprises performing an exact-string comparison.

14. The document auditing method of claim 13, wherein the relative comparison step comprises an alias-string comparison.

15. The document auditing method of claim 11, wherein the parameter reconciliation process comprises using a context-dependent deductive reasoning matching process.

16. The document auditing method of claim 15, wherein the context-dependent deductive reasoning matching process comprises using a versioning criterion.

17. The document auditing method of claim 11, wherein the parameter reconciliation process comprises using an optical-character-recognition dependent matching.

18. The document auditing method of claim 11, wherein the parameter reconciliation process comprises using a configuration dependent matching.

19. The document auditing method of claim 11, wherein the document is a loan document.

20. The document auditing method of claim 11, wherein the document is a batch of loan documents.
